(19) United States
(12) Patent Application Publication
(10) Pub. No.: US 2011/0149153 A1
(43) Pub. Date: Jun. 23, 2011

(54) APPARATUS AND METHOD FOR DTV CLOSED-CAPTIONING PROCESSING IN BROADCASTING AND COMMUNICATION SYSTEM

(75) Inventors: Jeho NAM, Seoul (KR); Jung-Youn KIM, Seoul (KR); Jin-Woo HONG, Daejeon (KR); Sang-Kwon SHIN, Daejeon (KR); Sangwoo AHN, Daejeon (KR); Won-Sik CHEONG, Daejeon (KR); Hyon-Gon CHOO, Daejeon (KR); Joo-Young LEE, Seoul (KR)

(73) Assignee: Electronics and Telecommunications Research Institute, Daejeon (KR)

(21) Appl. No.: 12/973,291

(22) Filed: Dec. 20, 2010

(30) Foreign Application Priority Data
Dec. 22, 2009 (KR) 10-2009-0129016

(51) Int. Cl. H04N 7/00

(52) U.S. Cl. 348/468; 348/E07.033

(57) ABSTRACT

An apparatus for extracting and creating a closed caption of a DTV stream in broadcasting and communication system, the apparatus comprising: a demultiplexer to receive the stream and demultiplex the received stream into additional information and a video stream; a decoder to receive and decode the video stream; an ST converter to receive PTS information, and convert PTS information into synchronization time information; a storage unit to store the demultiplexed additional information; an analyzer to receive the additional information and analyze CSD information; a closed caption extractor to receive the decoded data and the CSD information, and extract closed caption data; a closed caption file creator to create a closed caption file; a closed caption data processing unit to construct a segment-by-segment closed caption stream; a segmentation unit to construct a segment-by-segment stream; and a keyword search unit to provide the segment-by-segment stream corresponding to the keyword.

### CROSS-REFERENCE(S) TO RELATED APPLICATIONS

The present application claims priority of Korean Patent Application No. 10-2009-0129016, filed on Dec. 22, 2009, which is incorporated herein by reference in its entirety.

### BACKGROUND OF THE INVENTION

1. Field of the Invention

Exemplary embodiments of the present invention relate to an apparatus and method for digital television (DTV) closed-captioning processing; and, more particularly, to an apparatus and method for processing DTV closed-captions in a broadcasting and communication system.

2. Description of Related Art

Currently, TV broadcasting systems are in a state in which analog broadcasting and digital broadcasting exist together. Analog TV systems have been largely developed from initially black-and-white broadcasting to color broadcasting. However, since analog broadcasting has shortcomings in that it has a difficulty in transmission/reception and is largely influenced by noise, concern about digital broadcasting is increasing. Accordingly, in the current terrestrial TV broadcasting, broadcast signals of the conventional analog scheme coexist with broadcast signals of a digital scheme led by digital multimedia broadcasting (DMB). Due to a rapid increase in the number of devices capable of receiving broadcast signals based on the digital scheme, the efficiency of digital broadcasting, and stable transmission/reception of broadcast signals, the weight of the digital broadcasting is gradually increasing in the terrestrial TV broadcasting.

A digital TV (hereinafter, referred to as “DTV”) implies a TV broadcasting system processing all broadcasts, which are produced, edited, transmitted, and received, as digital signals. The DTV can overcome the shortcomings of an analog TV, that image and sound qualities are poor because mutually different signals are processed depending on the kinds of information, and users can view only limited channels. With transmission technology, the DTV can remove noise, reduce a ghost phenomenon, provide clearer images and sound than the conventional analog TV, and provide more channels by compressing signals without loss of information. In addition, the DTV can automatically correct signal errors occurring in the course of transmission, share contents on the Internet and so on with TV programs, and perform two-way communication with the user, including an Internet search through a TV. The DTV scheme is classified into the Advanced Television Systems Committee (ATSC) standard used in the United States and the Digital Video Broadcasting-Terrestrial (DVB-T) standard used in Europe. The ATSC standard used in the United States employs 8-level Vestigial Sideband (8-VSB) scheme as a modulation scheme, and the DVB-T used in Europe employs Coded Orthogonal Frequency Division Multiplexing (COFDM) scheme as a modulation scheme.

In addition, such digitalization of broadcasting makes it possible to ensure super high image quality and sound quality, and provides a 4 times increase effect in channel efficiency as compared with the analog system. In terms of viewers, such a digital scheme can provide the viewers with a high-quality broadcasting service which is difficult to be expressed in the analogy scheme, and enables the viewers to view various programs due to a great number of channels. Also, in terms of industry, a demand creation effect is expected due to popularization of transmitters/receivers for digital broadcasting and popularization of new contents. Currently, the terrestrial DTV technology of digital broadcasting is being developed as one national basic network, with networks installed all over the country.

Owing to generalization of digital broadcasting, it is becoming easy for general uses to access and possess broadcast contents. A digital broadcast stream transmitted in an MPEG-2 transport stream (TS) includes multiplexed various data, including not only audio/video signals but also Program Specific Information (PSI) and Program and System Information Protocol (PSIP). In connection with the TS, table information representing a relation between a program included in a stream and each program element, such as an image or sound stream, constituting the program has been stipulated in order to transmit a plurality of programs. The table information is PSI, in which four kinds of tables including a Program Association Table (PAT) and a Program Map Table (PMT) have been stipulated. PSI, such as a PAT and a PMT, is disposed in a payload within a TS packet in units called sections, and is transmitted. Since a PID of a PMT corresponding to a program number and so on are recorded in a PAT, and a PID of a PCR, an image, sound, and additional data, which are included in a corresponding program, are recorded, it is possible to extract only a TS packet constituting an objective program from a stream by making reference to the PAT and PMT. Also, the PSIP is a DTV transmission protocol used in North America, and is standardized by ATSC so as to provide an electronic program guide (EPG) and other additional services based on an MPEG-2 Video/AC-3 Audio scheme. In order to provide such a PSIP, there are six information tables as shown in Table 1 below.

TABLE 1

| Table | Function |
|---|---|
| System Time Table | Table having date and time |
| (STT) | information |
| Master Guide Table | Table having version number, size, |
| (MGT) | PID information of other tables |
| Virtual Channel | Table having virtual channel |
| Table (VCT) | information (Major/Minor Number, |
| | Short Name, etc.) of TS |
| Event Information | Table having event information (EPG) |
| Table (EIT) | of virtual channel |
| Extended Text Table | Table having detailed information of |
| (ETT) | event of virtual channel |
| Rating Region Table | Table having rating information of |
| (RRT) | program |

In addition, as still other broadcast data, there is closed caption data provided for DTV closed caption service. Closed caption broadcasting is a service showing dialog of a broadcast program as a written closed caption, and intends to eliminate “digital divide” through extension of broadcasting accessibility of a neglected class, such as physically handicapped persons, old and feeble persons, and foreigners. In Korea, DTV Closed Captioning standard was developed in June 2007, and Closed Captioning service should be provided in all broadcasting services by “The Bill of Anti-Discrimination against the Handicapped People and Right Protection” in April 2008.

DTV closed caption data has been multiplexed in an MPEG-2 bitstream, which is the transmission standard for digital broadcasting, and requires a separate closed caption extraction/reproduction device in order for a receiver to reproduce the closed caption. In addition, a closed caption file in PC environments has the form of a Synchronized Accessible Media Interchange (SAMI) standard, which is most widely used as a closed caption file standard in the inside and outside of the country.

It is necessary to develop a technology for effectively extract and create such a closed caption file.

### SUMMARY OF THE INVENTION

An embodiment of the present invention is directed to a closed caption processing apparatus and method for easily editing a closed caption.

Another embodiment of the present invention is directed to a closed caption processing apparatus and method for processing a closed caption at a high speed.

Another embodiment of the present invention is directed to a closed caption processing apparatus and method for increasing a search speed.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for extracting and creating a closed caption of a DTV stream and dividing the DTV stream using the crated closed caption in broadcasting and communication system includes: a demultiplexer configured to receive the stream and demultiplex the received stream into additional information and a video stream; a decoder configured to receive and decode the video stream; an ST converter configured to receive PTS information extracted from the decoded data, and convert the PTS information into synchronization time information; a storage unit configured to store the demultiplexed additional information; an analyzer configured to receive the additional information and analyze CSD information; a closed caption extractor configured to receive the decoded data and the analyzed CSD information, and extract closed caption data; a closed caption file creator configured to create a closed caption file using the converted synchronization time information and the extracted closed caption data; a closed caption data processing unit configured to receive a closed caption file and construct a segment-by-segment closed caption stream; a segmentation unit configured to receive the processed segment-by-segment closed caption stream, and construct a segment-by-segment stream; and a keyword search unit configured to search for a keyword from the closed caption data stream received from the segment-by-segment closed caption stream, and provide the segment-by-segment stream corresponding to the keyword.

In accordance with another embodiment of the present invention, a method for extracting and creating a closed caption of a DTV stream and dividing the DTV stream using the crated closed caption in broadcasting and communication system includes: receiving the stream and demultiplexing the received stream into additional information and a video stream; receiving and decoding the video stream; receiving PTS information extracted from the decoded data, and converting the PTS information into synchronization time information; storing the demultiplexed additional information; receiving the additional information and analyzing CSD information; receiving the decoded data and the analyzed CSD information, and extracting closed caption data; and creating a closed caption file using the converted synchronization time information and the extracted closed caption data; receiving a closed caption file and constructing a segment-by-segment closed caption stream; receiving the processed segment-by-segment closed caption stream, and constructing a segment-by-segment stream; and searching for a keyword from the closed caption data stream received from the segment-by-segment closed caption stream, and providing the segment-by-segment stream corresponding to the keyword.

In accordance with another embodiment of the present invention, an apparatus for stream distinction and search using a closed caption file in a broadcasting and communication system includes: a closed caption data processing unit configured to receive a closed caption file and construct a segment-by-segment closed caption stream; a segmentation unit configured to receive the processed segment-by-segment closed caption stream, and construct a segment-by-segment stream; and a keyword search unit configured to search for a keyword from the closed caption data stream received from the segment-by-segment closed caption stream, and provide the segment-by-segment stream corresponding to the keyword.

In accordance with another embodiment of the present invention, a method for stream distinction and search using a closed caption file in a broadcasting and communication system includes: receiving a closed caption file and constructing a segment-by-segment closed caption stream; receiving the processed segment-by-segment closed caption stream, and constructing a segment-by-segment stream; and searching for a keyword from the closed caption data stream received from the segment-by-segment closed caption stream, and providing the segment-by-segment stream corresponding to the keyword.

### BRIEF DESCRIPTION OF THE DRAWINGS

FIG. 1 is a view illustrating the configuration of an apparatus for DTV closed caption extraction and closed caption file creation in accordance with an embodiment of the present invention;

FIG. 2 is a conceptual view showing closed caption data arranged in order of frame reproduction time;

FIG. 3 is a view illustrating a closed caption connected with a final ST determination method;

FIG. 4 is a view illustrating the configuration of an apparatus capable of configuring segment-by-segment streams using a closed caption file;

FIG. 5 is a flowchart illustrating a method for temporal segmentation of broadcast contents using a closed caption file in accordance with an embodiment of the present invention;

FIGS. 6A and 6B show examples of closed caption data of news and current event discussion; and

FIG. 7 is a view illustrating an example of drama segmentation using closed caption data.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention provides a closed caption file creation method which makes it possible to extract closed caption data from a recorded/stored MPEG-2 transport stream (TS) file of a terrestrial DTV broadcasting program, and reproduce the extracted closed caption in synchronization with images, even in a general purpose multimedia reproducer commonly used in a PC environment.

FIG. 1 is a view illustrating the configuration of an apparatus for DTV closed caption extraction and closed caption file creation in accordance with an embodiment of the present invention.

Referring to FIG. 1, the apparatus for DTV closed caption extraction and closed caption file creation includes an MPEG-2 demultiplexer 110, a video decoder 120, an ST converter 130, a PMT buffer 140, an EIT buffer 150, a caption service descriptor analyzer 160, a closed caption extractor 170, and a closed caption file creator 180. In FIG. 1, the PMT buffer 140 and the EIT buffer 150 are called storage units. The operation procedure for DTV closed caption extraction and closed caption file creation will now be described with reference to FIG. 1.

The MPEG-2 demultiplexer 110 receives an image provided in the form of an MPEG-2 transport stream, and demultiplexes the received image into a video stream, program map table (hereinafter, referred to as “PMT”) information of program specific information (PSI), and event information table (hereinafter, referred to as “EIT”) information of program and system information protocol (PSIP). The video decoder 120 decodes the video stream demultiplexed by the MPEG-2 demultiplexer 110, extracts and transfers a presentation time stamp (hereinafter, referred to as “PTS”) to the ST converter, and transfers user data to the closed caption extractor. The PTS is a value indicating a time point when a decoded access unit is reproduced, and is expressed in units of the period of 1/300 times the system clock frequency (yielding 90 kHz). The ST converter converts a PTS stream received from the video decoder into an ST stream, and transfers the ST stream to the closed caption file creator. The “ST” represents a synchronization time. The PMT buffer 140 and the EIT buffer 150 store and transfer the PMT information and EIT information, obtained through the MPEG-2 demultiplexing, to the caption service descriptor analyzer 160. The caption service descriptor analyzer 160 transfers caption service descriptor (CSD) information to the closed caption extractor 170 through the use of the PMT information and EIT information, which have been received from the PMT buffer 140 and EIT buffer 150. The closed caption extractor 170 extracts closed caption data through the use of the CSD information and the user data, which have been received from the caption service descriptor analyzer 160 and the video decoder 120, respectively, and transfers the extracted closed caption data to the closed caption file creator 180. The closed caption file creator 180 creates a closed caption file through the use of the ST information and the closed caption data, which have been received from the ST converter 130 and the closed caption extractor 170, respectively.

The closed caption file created in the closed caption file creator 180 depicted in FIG. 1 may be used as an input to a segment-by-segment stream configuration apparatus depicted in FIG. 4, which will be disclosed.

Hereinafter, the closed caption file extraction and creation method will be described in detail into a closed caption file extraction procedure and a closed caption file creation procedure.

<Closed Caption Extraction Method>

A digital closed caption extraction method may be classified into a procedure of interpreting a caption service descriptor, a procedure of extracting an MPEG-2 video stream, and a procedure of extracting closed caption data. A closed caption extraction target is an MPEG-2 TS, which is a transmission unit of a terrestrial DTV broadcasting stream. A closed caption is extracted and interpreted by making reference to the ATSC A/65 standard, domestic/foreign TTA DTV closed caption broadcasting standards, the EIA-708-B standard, and the ATSC A/53 standard. This procedure is performed.

The caption service descriptor interpretation procedure is performed because a caption service descriptor (hereinafter, referred to as “CSD”) must be interpreted before extraction of a closed caption. The CSD represents a descriptor included in a PMT of PSI or an EIT of PSIP, which has been demultiplexed by the MPEG-2 demultiplexer 110, describes the type and attributes of a closed caption. Table 2 shows a bitstream syntax of a CSD.

TABLE 2

| Syntax | No. of Bits | Format |
|---|---|---|
| caption_service_descriptor( ) | 5 | uimsbf |
| { | 8 * 3 | uimsbf |
| ... | 1 | bslbf |
| number_of_services | | |
| for (i=0; | | |
| i<number_of_services; i++) { | | |
| language | | |
| ... | | |
| korean_code | | |
| ... | | |
| } | | |
| } | | |

In Table 2, “language” is a 3-byte code representing language information of a closed caption. Each language code is defined in ISO 639.2, wherein, for example, Korean is expressed as “kor.” “Korean_code” is a field defined only in the domestic closed caption broadcasting standard, and indicates whether closed caption language corresponds to completion type (0) or Unicode (1) when the closed caption language is Korean language. When the other fields have all been analyzed, closed captions transmitted after this time are interpreted based on CSD information.

In the MPEG-2 TS video stream extraction procedure, it is necessary to extract a video stream from an MPEG-2 TS because closed caption data included in the video stream. The MPEG-2 systems, which are digital broadcasting transmission standards, defines that a transport stream (TS) has a unit packet size of 188 bytes, and the data type (e.g. video, audio, etc.) of the payload in a TS can be identified through the packet identifier (PID) of a relevant packet header. Since a DTV broadcasting closed caption is included within a picture user data syntax in a video stream, it is necessary to extract an MPEG-2 TS video stream. User data is constructed as Table 3 below.

TABLE 3

| Syntax | No. of Bits | Format |
|---|---|---|
| user_data( ) { | 32 | bslbf |
| user_data_start_code | 32 | bslbf |
| ATSC_identifier | 8 | uimsbf |
| user_data_type_code | | |
| if (user_data_type_code | | |
| == ’0x03’) | | |
| cc_data( ) | | |
| ... | | |
| next_start_code( ) | | |
| } | | |

Finally, in the closed caption data extraction procedure, an extracted video stream includes a packetized elementary stream (PES). In the user data, a closed caption data (cc_data) field stipulated to insert closed caption data is defined, and has a configuration as shown in Table 4 below. The PES represents a stream constructed with packets of only a single information source at a stage directly before a program stream (PS) and a transport stream (TS) are constructed. In a closed caption data field, “cc_data 1” and “cc_data 2” indicate a first byte and a second byte, respectively, and closed caption data can be constructed as many as the value of “cc_count.”

TABLE 4

| Syntax | No. of Bits | Format |
|---|---|---|
| cc_data( ) { | 8 | bslbf |
| ... | 8 | bslbf |
| for(i=0 ; i<cc_count ; i++) { | | |
| ... | | |
| cc_data_1 | | |
| cc_data_2 | | |
| } | | |
| ... | | |
| } | | |

Closed caption data contructed through the above procedure corresponds to a packet layer. Thereafter, through analysis of the following service layer, coding layer, and interpretation layer, information about the configuration of a closed caption and closed caption data can be obtained.

### <Closed Caption File Creation Method>

The closed caption file creation method includes a synchronization time calculation procedure and a closed caption connection/disposition procedure. In accordance with an embodiment of the present invention, the closed caption file creation method uses a synchronized accessible media interchange (hereinafter, referred to as “SAMI”) as a closed caption file standard, wherein the SAMI is a closed caption file based on HTML. In order to create an SAMI file, a synchronization time (ST) with respect to a reproduced image and appropriate disposition of a closed caption reproduced at each ST are required. The SAMI file standard is applied to a closed caption connected in a synchronization time, which is determined through the synchronization time calculation procedure to be described later, in order to create a closed caption file (*.smi).

An SAMI file structure basically includes synchronization time information with a unit of millisecond (ms), at which a closed caption is reproduced. Since DTV broadcasting closed caption data is included in a video stream, a PTS included in the header of a video stream PES can be utilized as closed caption reproduction time information of an SAMI file. A PTS is a 33-bit field located in a PES header, and represents a reproduction time of a PES. The PST is expressed in a unit of system clock frequency, which can be converted into a unit of synchronization time of an SAMI file through the use of Equation 1:

ST=(PTS/90)−(PTSₛₜₐᵣₜ/90) Eq. 1

In a synchronization time extraction procedure, a PTS is divided by 90 kHz and is converted into a unit of second in order to obtain a value of SAMI in a unit of ms.

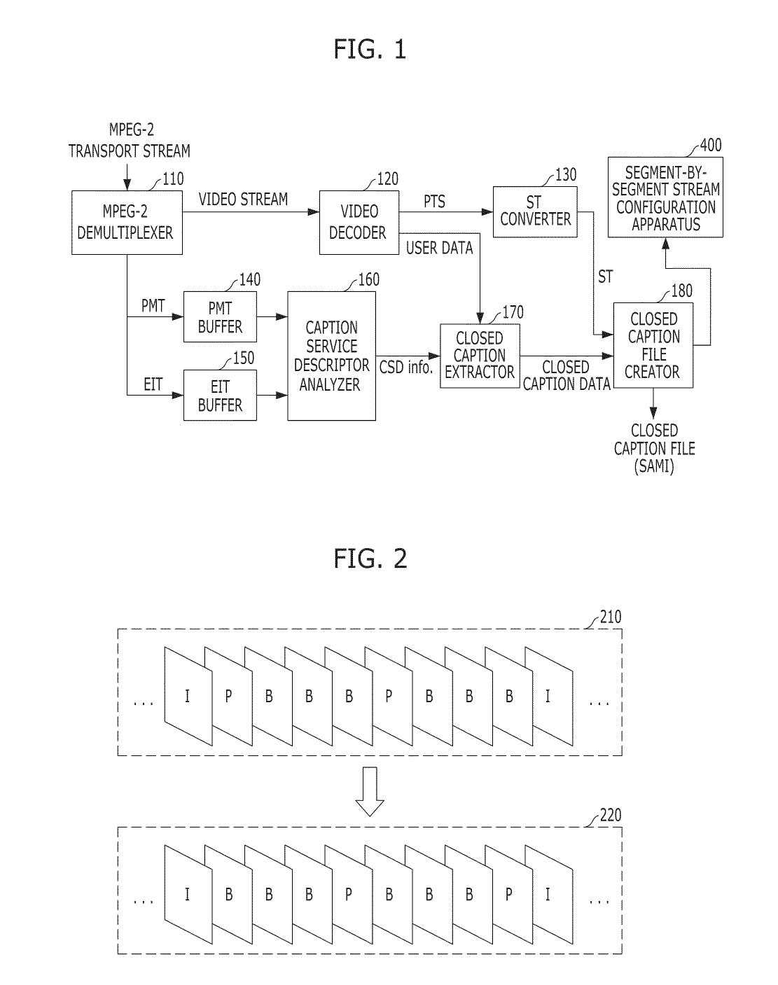

FIG. 2 is a conceptual view showing closed caption data arranged in order of frame reproduction time.

Reference numeral 210 denotes frames arranged in decoding order of PES video frames, and reference numeral 220 denotes frames arranged in order of frame reproduction time of closed caption data. When closed caption data is extracted in order of transmission, closed captions may be extracted in a different order. Since a PES is transmitted and stored in decoding order of video frames, closed captions must be extracted in order of PTSs, as indicated by reference numeral 210, that is, in order of frame reproduction time.

In order to arrange closed captions, which are extracted through the closed caption connection/disposition procedure, in the form of a complete word or sentence, a work of connecting closed captions extracted from a plurality of PESs in units of sentences or in units of predetermined lengths is required according to circumstances. As a criterion for determining the number of rows or columns of a closed caption displayed on a TV screen, “DefineWindow,” which is one of Command Descriptions defined in an interpretation layer in a DTV closed caption broadcasting standard, is used. In the “DefineWindow,” a row count and a column count (hereinafter, referred to as “row/column counts”) represent the number of rows and columns, respectively, displayed on the screen, and a row lock and a column lock (hereinafter, referred to as “row/column locks”) represent whether or not values expressed in the row/column counts are to be used as fixed values, respectively, on screen output. That is to say, a closed caption must be reproduced on the screen in accordance with a value expressed row/column counts when the value of the row/column locks is set to “Yes(1),” and the value of the row/column locks is not absolute on screen output when the value of the row/column locks is set to “No(0).” In accordance with an embodiment of the present invention, only the case where the value of the row/column locks is set to “No(0)” is taken into consideration for smooth disposition of a closed caption, wherein the values of the row/column counts are used as the maximum lengths of the closed caption to be disposed with each ST. According to closed captions, special characters of 1-byte ASCII code may exist, differently from the types (i.e. completion type or Unicode) of a Korean closed caption expressed in a Korean_code field of a CSD, and such special characters must be reflected in system design.

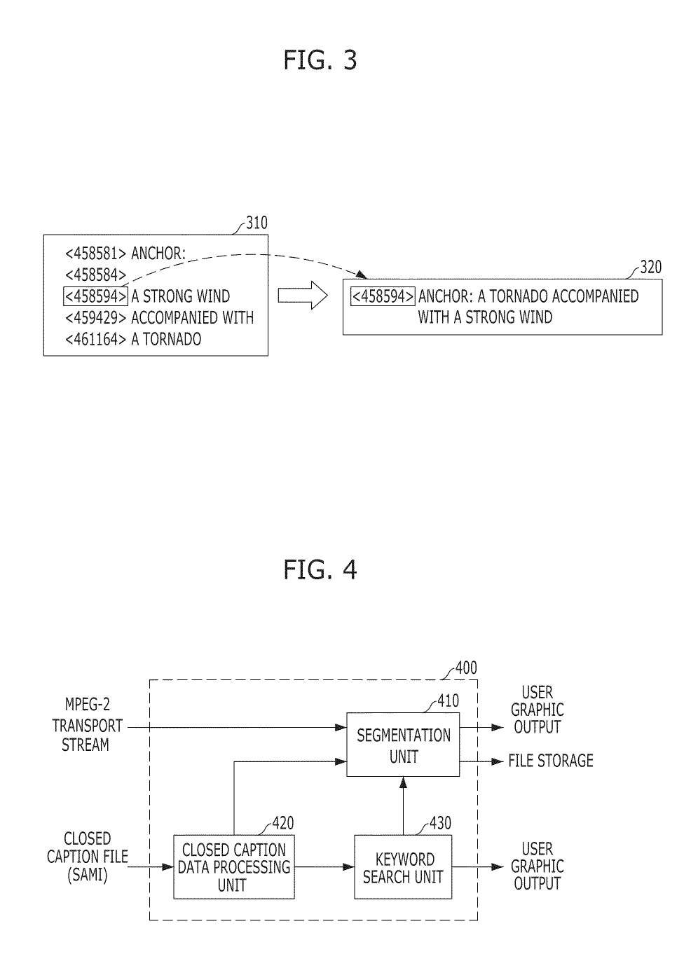

FIG. 3 is a view illustrating a closed caption connected with a final ST determination method.

In FIG. 3, reference numeral 310 indicates extracted STs and closed caption data corresponding to the extracted STs, and reference numeral 320 indicates a closed caption connected with a finally selected ST. As mutually separated closed captions are combined to one closed caption through the closed caption connection procedure, it is necessary to determine one ST representing the combined closed caption among a plurality of STs corresponding to the closed captions. In accordance with an embodiment of the present invention, an ST corresponding to a median closed caption of connected closed captions is determined as a final ST.

Also, in accordance with an embodiment of the present invention, the aforementioned closed caption file is used to provide a temporal segmentation method of broadcast contents.

The created closed caption file, described above, can be utilized as various application data, including video search and index, in addition to the basic function of displaying a closed caption on a multimedia reproducer. In accordance with an embodiment of the present invention, a temporal segmentation method of broadcast contents using closed caption data will now be described.

The genre of broadcast contents targeted by the temporal segmentation in accordance with an embodiment of the present invention includes news, discussion of current topics, and drama. In the case of domestic broadcasting, since closed caption data has characteristic information which is different depending on genres, it is necessary to apply different segmentation methods depending on genres of broadcast contents. Through the temporal segmentation, it is possible to obtain a start time of a segment, a reproduction time, and closed caption data of the corresponding segment. The temporal segmentation method in accordance with an embodiment of the present invention is performed through the use of pre-extracted closed caption data, thereby providing a higher division processing speed than the conventional video frame-based scene division method.

FIG. 4 is a view illustrating the configuration of an apparatus capable of configuring segment-by-segment streams using a closed caption file.

The apparatus of FIG. 4 includes a segmentation unit 410, a closed caption data processing unit 420, and a keyword search unit 430 in order to construct segment-by-segment streams using a closed caption file. The segment-by-segment stream configuration apparatus using a closed caption file will now be described with reference to FIG. 4. The closed caption data processing unit 420 receives a closed caption file together with a stream, and can set segments in the stream. For example, it is assumed that one news program includes n number of news articles, the closed caption data processing unit can construct n number of closed captions for segment-by-segment streams. The segmentation unit 410 receives an MPEG-2 TS, and constructs segment-by-segment streams using closed caption files for segment-by-segment streams, which have been constructed by the closed caption data processing unit 420. Also, a TS passing through the segmentation unit 410 may be output to the user, or may be stored as a segment-by-segment stream file. The keyword search unit 430 can output a stream of a desired segment through a keyword search from segment-by-segment closed caption stream data processed by the closed caption data processing unit 420. The keyword search unit 430 searchs a keyword in a closed caption data stream from the segment-by-segment closed caption stream and outputs a segment-by-segment stream corresponding to the keyword.

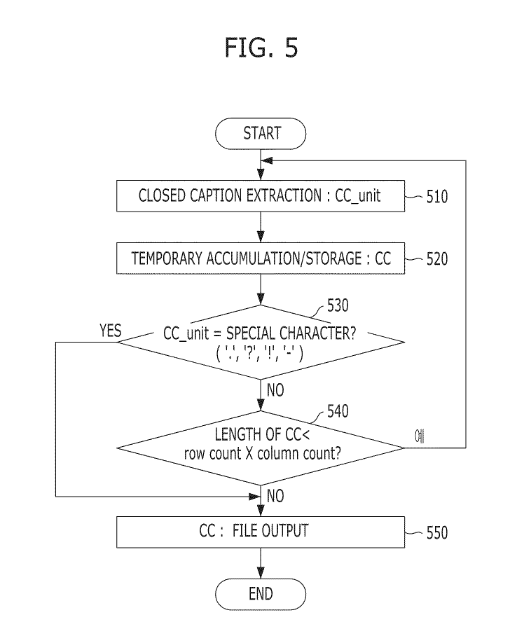

FIG. 5 is a flowchart illustrating a method for temporal segmentation of broadcast contents using a closed caption file in accordance with an embodiment of the present invention.

At step 510, a closed caption (CC_unit) is extracted. At step 520, the closed caption extracted at the step 510 is stored in a temporary accumulation storage device. At step 530, it is determined if the extracted closed caption is a special character. When the extracted closed caption is a special character, a file is output at step 550. When the extracted closed caption is not a special character, the length of temporary accumulated/stored closed captions is compared with the product of a row count and a column count, which represent the number of rows and columns to be displayed on a screen at step 540. The product of a row count and a column count represents a screen size in which a closed caption can be displayed. When the length of temporary accumulated/stored closed captions is less than the product of a row count and a column count at the step 540, the closed caption extraction is repeated. In contrast, when the length of temporary accumulated/stored closed captions is greater than the product of a row count and a column count at the step 540, the accumulated closed caption file is output at the step 550.

Hereinafter, the temporal segmentation method using a closed caption file will be described with examples of news, a current event discussion, and a drama.

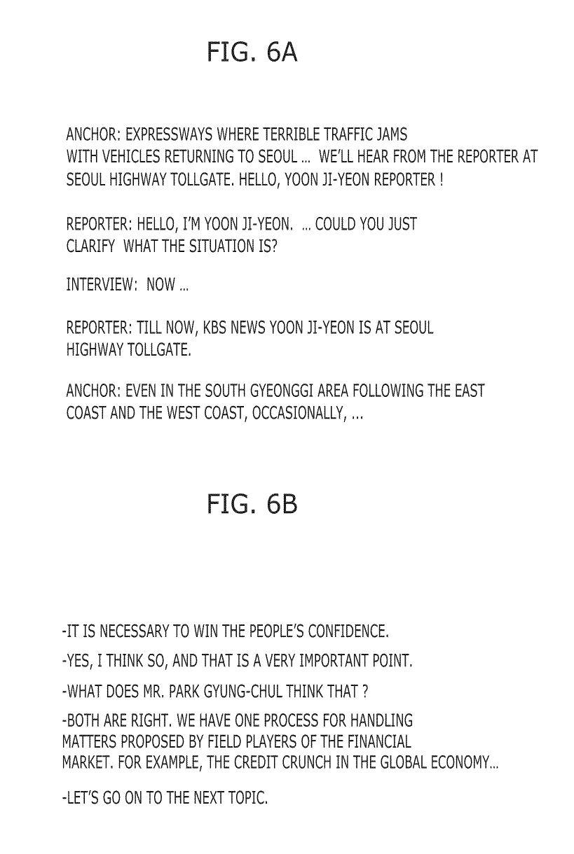

FIGS. 6A and 6B show examples of closed caption data of news and current event discussion.

Generally, a unit of segmentation in news is one article. A closed captions of domestic broadcast news includes a kind of tag for distinguishing a speaker, such as “Anchor:”, “Reporter:”, and “Interview:”, which are not actually spoken, and a piece of news generally includes predetermined words to finish an article. FIG. 6A shows an example of closed caption data of a news article, which can be distinguished based on the following criteria.
When “Anchor:” is output and then “Anchor:” is again output, it represents one independent news article.
When “Anchor:” is output, and then “Reporter:” is output before “Anchor:” is again output, the name of the reporter is stored. Thereafter, when a sentence of “[Broadcasting Station Name] news [Name of Reporter] is” is output, contents till which time are distinguished as one article.

As described above, by analyzing characteristic information of closed caption data of news, a broadcasting station name and a reporter name can be relatively easily obtained. In FIG. 6A, through the use of characteristic information, such as “Anchor:”, “Reporter:”, and “Interview:”, segment information can be obtained.

Also, in the case of a current event discussion in the Korean broadcasts, when a speaker is changed, a hyphen “-” is inserted into closed caption data so that hearing-impaired persons and foreigners can recognize the speaker change. FIG. 6B shows an example of closed caption data of a current event discussion, which includes a hyphen. In a current event discussion program, since each debater gives his/her opinion during a predetermined period of time, a time interval of speaker change is relatively long as compared with other broadcast genres, so that it is effective to divide segments according to speaker changes. Accordingly, in accordance with an embodiment of the present invention, through setting of the minimum segment interval and a hyphen, which is a speaker change mark, the temporal segmentation for current event discussion broadcast contents is performed. The minimum segment interval is a kind of segmentation threshold. When the minimum segment interval has been set, even a speaker change occurring within the set minimum segment interval is recognized as one continued segment. For example, when the minimum segment interval has been set to 20 seconds, a speaker change occurring within 20 seconds is ignored and is recognized as one continued segment, and a speaker change mark occurring after 20 seconds based on the start time point of a corresponding segment is recognized as starting a new segment. The setting of the minimum segment interval is achieved using a variable which can be freely set as the user pleases, and may be utilized as a function of setting the minimum segment length desired by the user.

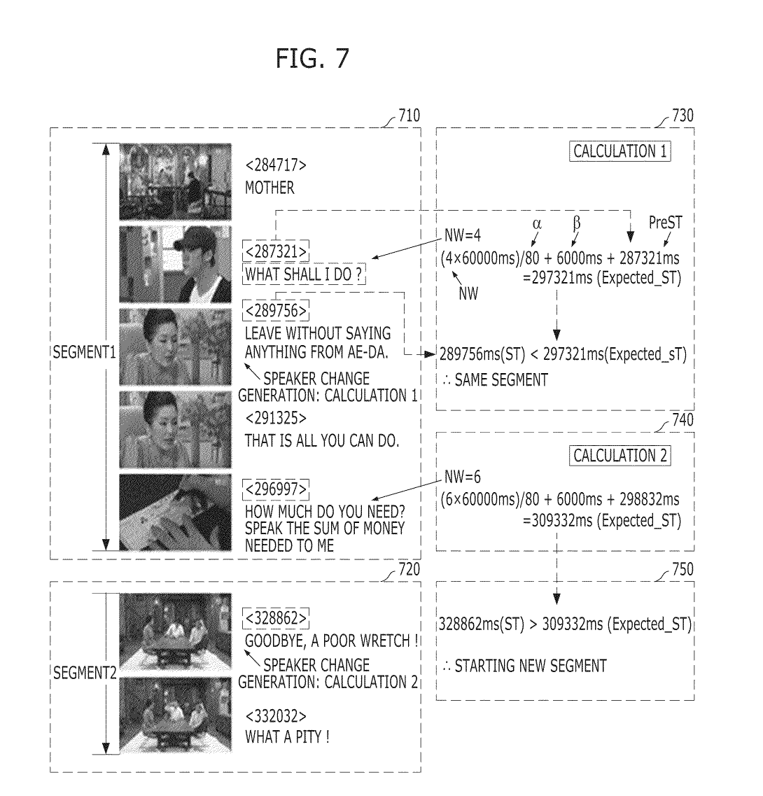

FIG. 7 is a view illustrating an example of drama segmentation using closed caption data.

In the case of a drama, temporal segmentation using a hyphen mark is possible, too. However, the scene division method for a current event discussion, described above, is inefficient due to the characteristics of the drama that a speaker change occurs frequently. Therefore, in accordance with an embodiment of the present invention, the drama segmentation method based on closed captions is as follows.

First, when speaker-changed closed caption data starting with a hyphen mark is received, an expected synchronization time “Expected_ST” of a speaker-changed closed caption may be calculated by Equation 2:

Expected_ST=(NW×60)/α+β+PreST Eq. 2

“NW” represents the number of words of a closed caption corresponding to a directly previous ST, and α and β represent the number of words spoken for one minute and a waiting time for a speaker change, respectively. The α and β are variables which can be freely set as the user pleases. As the value of α increases, the number of words spoken during one minute is set to a greater value, so that the value of the calculated Expected_ST becomes smaller. The β is a variable for setting a waiting time until the next closed caption is generated in addition to a time obtained by the α. Through the two values and the number of words obtained for a closed caption, the sum of the duration of the closed caption and a waiting time until the next closed caption is generated is expected. By adding a PreST representing the ST of a directly previous closed caption to the sum, the ST of a current speaker-changed closed caption is expected. The calculated Expected_ST is compared with the ST of the current speaker-changed closed caption, and the current speaker-changed closed caption is recognized as a new segment when the ST of the current speaker-changed closed caption is greater than the Expected_ST. The α and β are variables which can be controlled to exert an influence on the number of divided segments. As the α has a greater value, and/or as the β has a smaller value, the division generates more segments. In FIG. 7, segmentation may be performed based on calculation process 1 at step 730 and calculation process 2 at step 740, respectively. Through the calculation processes at the steps 730 and 740, it is possible to distinguish block 710 and block 720, i.e. segment 1 and segment 2. In the calculation process 1 at the step 730, an expected synchronization time “Expected_ST” of a speaker-changed closed caption can be obtained by substituting an NW value of 4 (What/shall/I/do?), an α value of 80, a β value of 6000 ms, a PreST value of 287321 ms, which is an ST value obtained through calculation, for Equation 2. The resultant value, i.e. the Expected_ST value is 297321 ms, which is compared with the next value of 289756 ms. Consequently, since the ST value of 289756 ms is less than the Expected_ST value of 297321, the current position is recognized as the same segment as that of the previous closed caption. In the calculation process 2 at the step 740, since the ST of a speaker-changed closed caption data is greater than the Expected_ST value, the current position is determined as starting a new segment.

The temporal segmentation method of a moving picture using a closed caption file in accordance with an embodiment of the present invention uses closed caption information, which expresses contents of the moving picture in the form of text, it is possible to provide very accurate and much information on search or the like, as compared with the conventional methods using video or audio information. Also, since the method in accordance with an embodiment of the present invention is based perfectly on text, a high-speed processing is possible, which can be more efficiently used on segmentation. For example, when the user repeats segmentation while changing parameter setting values in order to perform appropriate segmentation, the repetition processing can be rapidly performed without delay. In addition, information, including a closed caption file, segmentation information, a result of scene search, etc., can be easily converted into various forms of information text, including HTML and XML. Especially, the temporal segmentation information can be easily converted into metadata of MPEG-7 or TV-Anytime standard.

In accordance with the exemplary embodiments of the present invention, there is provided a closed caption processing apparatus and method which has advantages in that editing is easy, a processing speed is high, and a search speed can increase.

While the present invention has been described with respect to the specific embodiments, it will be apparent to those skilled in the art that various changes and modifications may be made without departing from the spirit and scope of the invention as defined in the following claims.

What is claimed is:

1. An apparatus for extracting and creating a closed caption of a DTV stream and dividing the DTV stream using the crated closed caption in broadcasting and communication system, the apparatus comprising:
a demultiplexer configured to receive the stream and demultiplex the received stream into additional information and a video stream;
a decoder configured to receive and decode the video stream;
an ST converter configured to receive PTS information extracted from the decoded data, and convert the PTS information into synchronization time information;
a storage unit configured to store the demultiplexed additional information;
an analyzer configured to receive the additional information and analyze CSD information;
a closed caption extractor configured to receive the decoded data and the analyzed CSD information, and extract closed caption data;
a closed caption file creator configured to create a closed caption file using the converted synchronization time information and the extracted closed caption data;
a closed caption data processing unit configured to receive a closed caption file and construct a segment-by-segment closed caption stream;
a segmentation unit configured to receive the processed segment-by-segment closed caption stream, and construct a segment-by-segment stream; and
a keyword search unit configured to search for a keyword from the closed caption data stream received from the segment-by-segment closed caption stream, and provide the segment-by-segment stream corresponding to the keyword.

2. The apparatus of claim 1, wherein the additional information comprises information of a program map table of PSI, and information of an event information table of PSIP.

3. The apparatus of claim 1, wherein the storage unit comprises:
an PMP buffer configured to store information of a program map table of PSI; and
an EIT buffer configured to store information of an event information table of PSIP.

4. A method for extracting and creating a closed caption of a DTV stream and dividing the DTV stream using the crated closed caption in broadcasting and communication system, the method comprising:
receiving the stream and demultiplexing the received stream into additional information and a video stream;
receiving and decoding the video stream;
receiving PTS information extracted from the decoded data, and converting the PTS information into synchronization time information;
storing the demultiplexed additional information;
receiving the additional information and analyzing CSD information;
receiving the decoded data and the analyzed CSD information, and extracting closed caption data;
creating a closed caption file using the converted synchronization time information and the extracted closed caption data;
receiving the closed caption file and constructing a segment-by-segment closed caption stream;
receiving the processed segment-by-segment closed caption stream, and constructing a segment-by-segment stream; and
searching for a keyword from the closed caption data stream received from the segment-by-segment closed caption stream, and providing the segment-by-segment stream corresponding to the keyword.

5. The method of claim 4, wherein the additional information comprises information of a program map table of PSI, and information of an event information table of PSIP.

6. The method of claim 4, wherein said storing the demultiplexed additional information comprises:
storing information of a program map table of PSI; and
storing information of an event information table of PSIP.

7. An apparatus for stream distinction and search using a closed caption file in a broadcasting and communication system, the apparatus comprising:
a closed caption data processing unit configured to receive a closed caption file and construct a segment-by-segment closed caption stream;
a segmentation unit configured to receive the processed segment-by-segment closed caption stream, and construct a segment-by-segment stream; and
a keyword search unit configured to search for a keyword from the closed caption data stream received from the segment-by-segment closed caption stream, and provide the segment-by-segment stream corresponding to the keyword.

8. The apparatus of claim 7, wherein the segment-by-segment stream divided by the segmentation unit is stored in a form of a file so as to be searched for.

9. A method for stream distinction and search using a closed caption file in a broadcasting and communication system, the method comprising:
receiving a closed caption file and constructing a segment-by-segment closed caption stream;
receiving the processed segment-by-segment closed caption stream, and constructing a segment-by-segment stream; and
searching for a keyword from the closed caption data stream received from the segment-by-segment closed caption stream, and providing the segment-by-segment stream corresponding to the keyword.

10. The method of claim 9, wherein the segment-by-segment stream is stored in a form of a file so as to be searched for.

11. The method of claim 9, wherein the method further comprising:
extracting the closed caption of the stream and storing the extracted closed caption;
comparing the extracted closed caption with a special character and performing an output operation; and
comparing a length of the stored closed caption with a size of a screen and outputting a comparison result.

12. The method of claim 11, wherein said comparing the extracted closed caption with a special character and outputting a comparison result comprises:
comparing the closed caption and the special character in order to search for an end of a segment;
outputting a file when the closed caption is equal to the special character; and
transitioning to said comparing a length of the stored closed caption with a size of a screen and performing an output operation when the closed caption is different from the special character.

13. The method of claim 11, wherein said comparing a length of the stored closed caption with a size of a screen and outputting a comparison result comprises:
comparing the length of the stored closed caption with the size of the screen;
outputting a file when the length of the stored closed caption is greater than the size of the screen; and
transitioning to said extracting the closed caption of the stream when the length of the stored closed caption is less than the size of the screen.
